(19) United States
(12) Patent Application Publication
(10) Pub. No.: US 2018/0116216 A1
(43) Pub. Date: May 3, 2018

(54) MICROBICIDAL COMPOSITION CONTAINING GLUTARALDEHYDE AND ORTHOPHENYLPHENOL

(71) Applicant: Dow Global Technologies LLC, Midland, MI (US)

(72) Inventor: Kathy Jing JI, Shanghai (CN)

(21) Appl. No.: 15/565,762

(22) PCT Filed: May 25, 2016
(86) PCT No.: PCT/US2016/034079

§ 371 Date: Oct. 11, 2017

Related U.S. Application Data
(60) Provisional application No. 62/168,842, filed on May 31, 2015.

(51) Int. Cl. A01N 35/02; A01N 31/08

(52) U.S. Cl. CPC A01N 35/02; A01N 31/08

(57) ABSTRACT

This invention relates to synergistic mixtures of orthophenolphenol and/or its sodium salt with glutaraldehyde and the use of the synergistic combinations in industrial applications.

This invention relates to synergistic mixtures of o-phenylphenol and/or its sodium salt with glutaraldehyde and the use of the synergistic combinations in industrial applications.

O-phenylphenol and sodium orthophenylphenate (separately or collectively herein known as “OPP”, orthophenolphenol or o-phenylphenol and/or its sodium salt) are known and used extensively as antimicrobial agents in various industrial applications such as preservation of various materials including paints and adhesives as well as to control unwanted microorganisms found in various process waters such as cooling water, paper mills and petroleum production process waters.

The contamination of various products with microbiological growth has led to the study and application of large classes of preservatives, antimicrobial compositions, and microbiocides to inhibit or prevent such contamination. Industrial process waters also have been studied and treated extensively. Preservatives are used in a broad range of products including but not limited to adhesives, cosmetics and toiletries, disinfectants and sanitizers, leather, metalworking fluids, paints and coatings, plastics and resins, latex polymers, textiles and wood. Failure to preserve these products adequately will result in spoilage and loss of the materials to be preserved and will result in an economic loss. Similarly, microbiological growths can have dire consequences if process waters are not adequately treated. Process waters include but are not limited to: industrial recirculating water, paper products (i.e., paper), petroleum production and leather tanning. Process waters are of concern because when fouled with biofilms that develop from the indigenous microbes present, bioflims may develop into thick gelatinous like masses. Slime is produced by a wide range of bacteria, fungi, and yeast. Slime will interfere with the process resulting in a loss of heat transfer, corrosion and fouling.

Some of the microorganisms responsible for the extensive economic effects described above have exhibited resilient resistant tendencies against the standard and widely used microbiocides and antimicrobial compositions, and accordingly the search for more effective antimicrobials has extended to a search for synergistic combinations of materials considered to be relatively safe for humans. There remains a need for combinations of materials of low or nonexistent toxicity to humans which are effective against a wide range of microorganisms.

### STATEMENT OF THE INVENTION

The present invention is directed to a microbicidal composition comprising: (a) orthophenolphenol; and (b) glutaraldehyde.

### DETAILED DESCRIPTION OF THE INVENTION

As used herein, the following terms have the designated definitions, unless the context clearly indicates otherwise. “Orthophenolphenol” means O-phenylphenol and sodium orthophenylphenate (separately or collectively herein known as “OPP”, orthophenolphenol or o-phenylphenol and/or its sodium salt or “SOPP”. In the present invention orthophenolphenol is preferably orthophenylphenol in sodium salt form or SOPP. “Glutaraldehyde” means Pentane-1,5-dial (CAS Registry 111-30-8). The term “microbicide” is synonymous with “biocide” and refers to a compound capable of killing, inhibiting the growth of or controlling the growth of microorganisms at a locus; microbicides include bactericides, fungicides and algaecides. The term “microorganism” includes, for example, fungi (such as yeast and mold), bacteria and algae, preferably bacteria. The term “locus” refers to an industrial system or product subject to contamination by microorganisms. The following abbreviations are used throughout the specification: ppm=parts per million by weight (weight/weight), mL=milliliter, ATCC=American Type Culture Collection, MBC=minimum biocidal concentration, and MIC=minimum inhibitory concentration. Unless otherwise specified, temperatures are in degrees centigrade (° C.), and references to percentages (%) are by weight. Amounts of organic microbicides are given on an active ingredient basis in ppm (w/w).

The compositions of the present invention unexpectedly have been found to provide enhanced microbicidal efficacy at a combined active ingredient level lower than that of the individual microbicides. Additional microbicides beyond those listed in the claims may be present in the composition.

The antimicrobial composition comprises glutaraldehyde and orthophenolphenol. A suitable weight ratio of glutaraldehyde to orthophenolphenol is from 1:2.2 to 1:28.7.

The microbicides in the composition of this invention may be used “as is” or may first be formulated with a solvent or a solid carrier. Suitable solvents include, for example, water; glycols, such as ethylene glycol, propylene glycol, diethylene glycol, dipropylene glycol, polyethylene glycol, and polypropylene glycol; glycol ethers; alcohols, such as methanol, ethanol, propanol, phenethyl alcohol and phenoxypropanol; ketones, such as acetone and methyl ethyl ketone; esters, such as ethyl acetate, butyl acetate, triacetyl citrate, and glycerol triacetate; carbonates, such as propylene carbonate and dimethyl carbonate; and mixtures thereof. It is preferred that the solvent is selected from water, glycols, glycol ethers, esters and mixtures thereof. Suitable solid carriers include, for example, cyclodextrin, silicas, diatomaceous earth, waxes, cellulosic materials, alkali and alkaline earth (e.g., sodium, magnesium, potassium) metal salts (e.g., chloride, nitrate, bromide, and sulfate) and charcoal.

When a microbicide component is formulated in a solvent, the formulation may optionally contain surfactants. When such formulations contain surfactants, they are generally in the form of emulsive concentrates, emulsions, microemulsive concentrates, or microemulsions. Emulsive concentrates form emulsions upon the addition of a sufficient amount of water. Microemulsive concentrates form microemulsions upon the addition of a sufficient amount of water. Such emulsive and microemulsive concentrates are generally well known in the art; it is preferred that such formulations are free of surfactants. U.S. Pat. No. 5,444,078 may be consulted for further general and specific details on the preparation of various microemulsions and microemulsive concentrates.

A microbicide component also can be formulated in the form of a dispersion. The solvent component of the dispersion can be an organic solvent or water, preferably water. Such dispersions can contain adjuvants, for example, co-solvents, thickeners, anti-freeze agents, dispersants, fillers, pigments, surfactants, biodispersants, sulfosuccinates, terpenes, furanones, polycations, stabilizers, scale inhibitors and anti-corrosion additives.

Those skilled in the art will recognize that the microbicide components of the present invention may be added to a locus sequentially, simultaneously, or may be combined before being added to the locus. It is preferred that the first microbicide and the second microbicide component be added to a locus simultaneously or sequentially. When the microbicides are added simultaneously or sequentially, each individual component may contain adjuvants, such as, for example, solvent, thickeners, anti-freeze agents, colorants, sequestrants (such as ethylenediamine-tetraacetic acid, ethylenediaminedisuccinic acid, iminodisuccinic acid and salts thereof), dispersants, surfactants, biodispersants, sulfosuccinates, terpenes, furanones, polycations, stabilizers, scale inhibitors and anti-corrosion additives.

The microbicidal compositions of the present invention can be used to inhibit the growth of microorganisms or higher forms of aquatic life (such as protozoans, invertebrates, bryozoans, dinoflagellates, crustaceans, mollusks, etc.) by introducing a microbicidally effective amount of the compositions onto, into, or at a locus subject to microbial attack. Suitable loci include, for example: industrial process water; electrocoat deposition systems,; cooling towers; air washers; gas scrubbers; mineral slurries; wastewater treatment; ornamental fountains; reverse osmosis filtration; ultrafiltration; ballast water; evaporative condensers; heat exchangers; pulp and paper processing fluids and additives; starch; plastics; emulsions; dispersions; paints; latices; coatings, such as varnishes; construction products, such as mastics, caulks, and sealants; construction adhesives, such as ceramic adhesives, carpet backing adhesives, and laminating adhesives; industrial or consumer adhesives; photographic chemicals; printing fluids; household products, such as bathroom and kitchen cleaners and sanitary wipes; cosmetics; toiletries; shampoos; soaps; detergents; industrial cleaners; floor polishes; laundry rinse water; metalworking fluids; conveyor lubricants; hydraulic fluids; leather and leather products; textiles; textile products; wood and wood products, such as plywood, chipboard, wallboard, flakeboard, laminated beams, oriented strandboard, hardboard, and particleboard; petroleum processing fluids; fuel; oilfield fluids, such as injection water, fracture fluids, and drilling muds; agriculture adjuvant preservation; surfactant preservation; medical devices; diagnostic reagent preservation; food preservation, such as plastic or paper food wrap; food, beverage, and industrial process pasteurizers; toilet bowls; recreational water; pools; and spas.

Preferably, the microbicidal compositions of the present invention are used to inhibit the growth of microorganisms at a locus selected from one or more of mineral slurries, pulp and paper processing fluids and additives, starch, emulsions, dispersions, paints, latices, coatings, construction adhesives, such as ceramic adhesives, carpet backing adhesives, photographic chemicals, printing fluids, household products such as bathroom and kitchen cleaners and sanitary wipes, cosmetics, toiletries, shampoos, soaps, detergents, industrial cleaners, floor polishes, laundry rinse water, metal working fluids, textile products, wood and wood products, agriculture adjuvant preservation, surfactant preservation, diagnostic reagent preservation, food preservation, and food, beverage, and industrial process pasteurizers.

The specific amount of the composition of this invention necessary to inhibit or control the growth of microorganisms and higher aquatic life forms in a locus depends upon the particular locus to be protected. Typically, the amount of the composition of the present invention to control the growth of microorganisms in a locus is sufficient if it provides from 0.1 to 1,000 ppm of the sodium orthophenolphenol ingredient of the composition in the locus. It is preferred that the sodium orthophenolphenol ingredients of the composition be present in the locus in an amount of at least 5 ppm, more preferably at least 10 ppm and most preferably at least 20 ppm. It is preferred that the sodium orthophenolphenol ingredients of the composition be present in the locus in an amount of no more than 0.8%, more preferably no more than 0.5%, and most preferably no more than 0.1%.

### EXAMPLES

### Materials and Methods

### Biocides Used

Two biocides and their combinations were tested at different concentration ranges. These biocides are DOWICIDE A, and UCARCIDE 50. All biocide solutions were prepared and diluted in sterile DI water and used within 2 hours. These biocides are commercially available from The Dow Chemical Company.

TABLE 1
Biocides

| Commercial Biocides | Active |
|---|---|
| UCARCIDE 50 | 50% Glutaraldehyde |
| DOWICIDE A | 71.7% sodium orthophenylphenol |

### Bacterial Culture

TABLE 2
Bacterial cultures used for time kill test

| Bacteria | |
|---|---|
| Pseudomonas aeruginosa | ATCC# 15442 |
| Pseudomonas aeruginosa | ATCC# 10145 |
| Enterobacter aerogenes | ATCC# 13048 |
| Escherichia coli | ATCC# 11229 |
| Klebsiella pneumoniae | ATCC# 8308 |
| Staphylococcus aureus | ATCC# 6538 |
| Salmonella choleraesuis | ATTC# 10708 |

A bacteria pool was used for testing. 24 hr bacterial cultures were obtained in TSB (Tryptic Soy Broth) media at 37° C. incubation for the seven organisms. The bacterial pool of seven organism was prepared by taking equal parts of a 24 hour stationary phase aliquot from each bacterial culture and mixing them together. The starting bacterial concentration within the test sample is at 1×10⁶˜1×10⁷ CFU/ml.

### Dow Time-Kill Test

The time-kill tests were carried out to determine the threshold concentration of the biocide products in a pH 7.4 hand dish-washing liquid. Tests were conducted in a 96-deep well block format using a total sample volume of 600 ul for all evaluations. The hand dish-washing sample was pre-contaminated with the bacterial culture at the final bacterial concentration of at 1×10⁶˜1×10⁷ CFU/ml. Biocides were then added into this bacterial suspension at various levels and mixed immediately. The mixed samples were then incubated at 37° C. At 24 hrs, viable bacteria remaining in the hand dish-washing samples were determined by 1:10 serial dilutions, transferring 20 ul aliquot of each sample into 180 ul TSB/Resazurin media. Triplicate tests were conducted. MPN method was used to determine the microbial concentration after 24 hours incubation at 37° C.

The following table details the threshold concentration at 24 hours to achieve >=4 log bacterial count reduction of tested biocide.

TABLE 3
Concentration required to achieve >=4 Log
bacterial counts reduction of tested biocides

| Time | 24 h |
|---|---|
| Glutaraldehyde | 100 |
| (“Glut”) alone | |
| SOPP alone | 358.5 |

### Synergy Index

The synergism of the combination of the present invention was demonstrated by testing a wide range of concentrations and ratios of the compounds.

One measure of synergism is the industrially accepted method described by Kull, F. C.; Eisman, P. C.; Sylwestrowicz, H. D. and Mayer, R. L., in Applied Microbiology 9:538-541 (1961), using the ratio determined by the formula:

Qₐ/Q_{A}+Q_{b}/Q_{B}=Synergy Index (“SI”)

wherein:
Q_{A}=concentration of compound A (first component) in ppm, acting alone, which produced an end point (MIC of Compound A).
Qₐ=concentration of compound A in ppm, in the mixture, which produced an end point.
Q_{B}=concentration of compound B (second component) in ppm, acting alone, which produced an end point (MIC of Compound B).
Q_{b}=concentration of compound B in ppm, in the mixture, which produced an end point.

When the sum of Qₐ/Q_{A} and Q_{b}/Q_{B} is greater than one, antagonism is indicated. When the sum is equal to one, additivity is indicated, and when less than one, synergism is demonstrated. The lower the SI, the greater the synergy shown by that particular mixture. The minimum inhibitory concentration (MIC) of a microbicide is the lowest concentration tested under a specific set of conditions that prevents the growth of added microorganisms.

The test results for demonstration of synergy of the SOPP combinations of the present invention are shown below in Tables 4 and 5. Each table shows the specific combinations of SOPP and glutaraldehyde; results against the microorganisms tested at 24 hours; the end-point activity in ppm for SOPP alone (Q_{B}), for glutaraldehyde alone (Q_{A}), for SOPP in the mixture (Q_{b}) and for the glutaraldehyde in the mixture (Qₐ); the calculated SI value; and the range of synergistic ratios for each combination tested (glutaraldehyde/SOPP or A/B).

Ratios of the two biocides exhibiting synergy are presented in Tables 4 and 5.

TABLE 4

| | Minimum | | |
|---|---|---|---|
| | Inhibitory | | |
| Active Weight | Concentration | | |
| ratio of | (ppm) | | Synergy |
| Glut and SOPP | Glut | SOPP | Index |

Bacterial Pool

| | | | |
|---|---|---|---|
| Glut alone | 100 | 0 | |
| SOPP alone | 0.00 | 358.5 | |
| 1:7.2 | 25 | 179.25 | 0.75 |
| 1:14.3 | 12.5 | 179.25 | 0.63 |
| 1:28.7 | 6,25 | 179.25 | 0.56 |

The synergistic effect of Glutaraldehyde to SOPP was demonstrated at the ratio 1:7.2 to 1:28.7

TABLE 5

| | Minimum | | |
|---|---|---|---|
| | Inhibitory | | |
| Active Weight | Concentration | | |
| ratio of | (ppm) | | Synergy |
| Glut and SOPP | Glut | SOPP | Index |

Bacterial Pool

| | | | |
|---|---|---|---|
| Glut alone | 100 | 0 | |
| SOPP alone | 0.00 | 358.5 | |
| 1:2.2 | 50 | 107.55 | 0.80 |
| 1:4.3 | 25 | 107.55 | 0.55 |
| 1:8.6 | 12.5 | 107.55 | 0.43 |

The synergistic effect of Glutaraldehyde to SOPP was demonstrated at the ratio of 1:2.2 to 1:8.6

1. A microbicidal composition comprising:
(a) glutaraldehyde; and
(b) orthophenolphenol.

2. The microbicidal composition of claim 1 in which the weight ratio of glutaraldehyde to orthophenolphenol is from 1:2.2 to 1:28.7.

3. A method of inhibiting the growth of microorganisms comprising adding the composition of claim 1 into an: industrial process water; electrocoat deposition systems,; cooling towers; air washers; gas scrubbers; mineral slurries; wastewater treatment; ornamental fountains; reverse osmosis filtration; ultrafiltration; ballast water; evaporative condensers; heat exchangers; pulp and paper processing fluids and additives; starch; plastics; emulsions; dispersions; paints; latices; coatings, construction products, construction adhesives, industrial or consumer adhesives; photographic chemicals; printing fluids; household products, cosmetics; toiletries; shampoos; soaps; detergents; industrial cleaners; floor polishes; laundry rinse water; metalworking fluids; conveyor lubricants; hydraulic fluids; leather and leather products; textiles; textile products; wood and wood products,; petroleum processing fluids; fuel; oilfield fluids; agriculture adjuvant preservation; surfactant preservation; medical devices; diagnostic reagent preservation; food preservation; food, beverage, and industrial process pasteurizers; toilet bowls; recreational water; pools; and spas.
